(19) United States
(12) Patent Application Publication
(10) Pub. No.: US 2018/0156644 A1
(43) Pub. Date: Jun. 7, 2018

(54) METHOD AND DEVICE FOR COUNTING SHOTS FIRED FROM A HANDGUN

(71) Applicant: STEFAN LIENHART, GRAZ (AT)

(72) Inventor: STEFAN LIENHART, GRAZ (AT)

(21) Appl. No.: 15/826,055

(22) Filed: Nov. 29, 2017

(30) Foreign Application Priority Data
Dec. 1, 2016 (AT) A51091/2016

(51) Int. Cl. G01D 9/00; G01P 15/18; H04R 29/00; H04R 1/02; H04R 3/00

(52) U.S. Cl. CPC G01D 9/00; G01P 15/18; H04R 3/00; H04R 1/028; H04R 29/00

(57) ABSTRACT

A device for detecting shots fired by a handgun contains an acceleration sensor that is implemented to measure the acceleration of the hand, a noise sensor that is implemented to measure the sound pressure level of the sound of the shot, and a processing unit, to which the acceleration sensor and the noise sensor are connected and to which the measurement results of the acceleration sensor and of the noise sensor are forwarded. The device is implemented to detect a shot if the respective signals forwarded by the acceleration sensor and the noise sensor each exceed a predetermined threshold value within a predetermined time period. The device has an attachment for attaching the acceleration sensor and the noise sensor to a hand and/or to a wrist, in particular so as to move in synchronism with the hand and/or wrist.

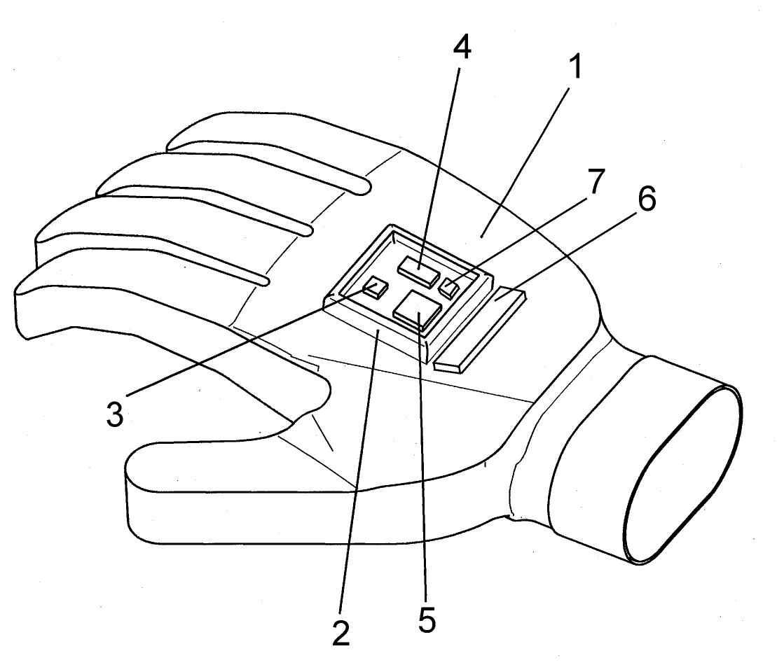

### CROSS-REFERENCE TO RELATED APPLICATION

This application claims the benefit, under 35 U.S.C. § 119, of Austrian patent application AT A51091/2016, filed Dec. 1, 2016; the prior application is herewith incorporated by reference in its entirety.

### BACKGROUND OF THE INVENTION

### Field of the Invention

The invention concerns a device for counting shots fired by means of a handgun according to the main patent claim.

Handguns usually have no function for detecting the shots fired thereby. The installation or the attachment of a counter in or to the handgun is a risk factor for the occurrence of a malfunction of the handgun.

### SUMMARY OF THE INVENTION

It is the object of the invention to detect the shots fired by a handgun without having to make changes to the handgun.

The invention achieves the object with the characterizing features of the main claim. The advantage is that the direct attachment of a shot counting device to the handgun is not necessary for detecting the shots.

According to the invention, a device for detecting the shots fired by a handgun is provided. The device comprises an acceleration sensor that is implemented to measure the acceleration of the hand, a noise sensor that is implemented to measure the sound pressure level of the sound of the shot, and a processing unit to which the acceleration sensor and noise sensor are connected and to which the measurement results of the acceleration sensor and of the noise sensor are forwarded and that is implemented to detect a shot if the respective signals forwarded by the acceleration sensor and noise sensor each exceed a predetermined threshold value within a predetermined time period. A device according to the invention is characterized by an attachment device for the attachment of the acceleration sensor and of the noise sensor to a hand and/or to a wrist, especially so as to move in synchronism with the hand and/or wrist.

The device according to the invention thus advantageously enables the shots fired by a handgun to be detected without changes having to be made to the handgun. The device is suitable to enable the reliable detection of a shot by a combination of the measurement values of the acceleration of the hand triggered by the shot being fired with the measurement values of the sound of the shot.

The acceleration sensor is suitable for measuring the acceleration during hand movements. The accelerations usually lie in the region of 1.6 g (16 m/s²). If a shot is fired from a handgun, a recoil movement occurs with an acceleration of approx. 78.5 m/s². If the threshold value is placed in a range from 22.5 m/s² to 61.5 m/s², it is possible to detect an acceleration of the hand exceeding the threshold value as a shot being fired.

The shot causes a bang that is loudest in the immediate vicinity of the handgun and the sound pressure level there reaches approximately 158 dB. In order to obtain reliable results with conventional handguns, it is advantageous that a shot is only detected if a shot has actually been fired and if the shot was fired by the relevant handgun. In order to meet the prerequisites, it can be provided that the processing unit is implemented to detect a shot if the measurement value forwarded by the acceleration sensor exceeds a threshold value of 22.5 m/s² to 61.5 m/s² and/or the sound pressure level measured by the noise sensor exceeds a threshold value between 145 and 155 dB.

In order to avoid erroneous detections of shots owing to movements of the shooter and/or owing to the firing noise of other weapons, it can be provided that the processing unit is implemented to detect a shot if the signals of the acceleration sensor and of the noise sensor exceeding the predetermined threshold value lie within no more than 3 milliseconds.

In order to be able to analyze the detection of the shots in the simplest possible way, the processing unit can be embodied to increase the counter reading on the detection of a shot.

In order to make the counter reading visible to the shooter any time, a display panel for indicating the counter reading can be provided.

In order to enable an analysis at a later point in time, a memory medium for storing the counter reading can be provided.

For the analysis of the detected shots, it can also be provided that the processing unit is implemented to detect the time interval between two shots. In this case, both the time separation between two directly successive shots and the time separation between the first and the last shot of a predetermined number of shots can be detected.

In order to make the data obtained available to the shooter immediately, a display panel for indicating the time interval between two shots can be provided.

For the external detection and processing of shots fired, it can be provided that the processing unit is implemented to relay the detection of a shot to an external unit. Advantageously, in order to protect the sensors, the processing unit and possibly the memory medium and/or the display against external influences such as impacts or wetness, it can be provided that the sensors and the processing unit and possibly the memory medium and/or the display are installed in a common housing.

The attachment device for the attachment of the device to a hand and/or wrist can be embodied as an armband, in the form of attachment bands or as hook and loop straps. Preferably, the attachment device can be embodied as a glove and an acceleration sensor, a noise sensor and a processing unit can be disposed on the rear part of the glove, in particular on the side of the rear part of the glove facing away from the back of the hand. As a result, particularly reliable detection of the shot is enabled, because immediate proximity to the handgun is produced, the acceleration of the hand movement is reproduced exactly and slipping of the device is excluded.

The acceleration sensor can be embodied to determine an acceleration vector with at least two, in particular three, acceleration components. The signals relating to the individual acceleration components are delivered to the processing unit and the processing unit is implemented to compare each acceleration component produced at the same time or within a predetermined time window separately with separate threshold values. The processing unit is implemented to detect a shot for the case in which one, a predetermined number or all of the threshold comparisons indicates or has indicated a threshold value being exceeded and the respective signal forwarded by the noise sensor exceeds the predetermined threshold value.

In order to enable particularly reliable detection of shots, it can be provided that the acceleration sensor is in particular attached to the rear of the hand side of the glove such that the acceleration sensor determines the first acceleration component in the direction of an x-axis that is oriented parallel to the fingers. The acceleration sensor determines the second acceleration component in the direction of a y-axis that lies in the plane of the surface of the back of the hand and that is oriented normally to the x-axis, and the acceleration sensor determines the third acceleration component in the direction of a z-axis that is normal to the x-axis and the y-axis. The individual components of the acceleration vector relative to the aforementioned axes or coordinate directions are approximately in the ranges mentioned below when a shot is fired: In the x-direction acceleration components occur in the range from 63.5 m/s² to 92.5 m/s². In the y-direction acceleration components occur in the range from 60.5 m/s² to 80.5 m/s². In the z-direction acceleration components occur in the range from 38 m/s² to 54 m/s².

The processing unit can be embodied to compare the first acceleration component with a first acceleration threshold value that lies between 34 m/s² and 61.5 m/s², to compare the second acceleration component with a second acceleration threshold value that lies between 30.5 m/s² and 46 m/s², and to compare the third acceleration component with a third acceleration threshold value that lies between 22.5 m/s² and 34.5 m/s².

A method for detecting the shots fired by a handgun is also in accordance with the invention. The acceleration of the hand is measured by an acceleration sensor and the sound pressure level of the sound of the shot is measured by a noise sensor. The firing of a shot with the handgun is detected if the respective signals forwarded by the acceleration sensor and the noise sensor each exceed a predetermined threshold value within a predetermined time period. The acceleration sensor and the noise sensor are attached to a hand and/or to a wrist of the shooter, in particular so as to move in synchronism with the hand and/or the wrist, before shots are fired.

Advantageously, the firing of a shot is detected if the measurement value forwarded by the acceleration sensor exceeds a threshold value of 22.5 m/s² to 61.5 m/s² and/or the sound pressure level measured by the noise sensor exceeds a threshold value between 145 and 155 dB.

In order to guarantee reliable detection, advantageously the firing of a shot is detected if the signals of the acceleration sensor and of the noise sensor exceeding the predetermined threshold value are detected within no longer than 3 milliseconds.

In order to facilitate the analysis, a counter reading can be incremented if the firing of a shot is detected.

Advantageously, the counter reading is indicated to the shooter, in particular on a display that is disposed in the region of the back of his hand or his wrist, and/or the counter reading is stored or forwarded to an external unit.

The analysis can also be facilitated by detecting the time interval between two shots. In this case, the processing unit can determine the time interval between two or more successive shots. The interval between the first and the last shots of a number of shots can also be determined.

It is advantageous in this case if the time interval between two shots is indicated to the shooter. In addition to or instead of this, exceeding a predetermined maximum value for the time interval between two shots can be indicated to the shooter on a display. In addition to or instead of this, the data can also be stored or forwarded to an external unit.

Advantageously, the acceleration sensor and the noise sensor can be attached to a glove, in particular to the rear of the hand part of the glove, preferably to the side of the rear of the hand part of the glove facing away from the back of the hand.

Further, an acceleration vector with three acceleration components can be determined and said acceleration components can be separately compared with separate threshold values. A shot is detected in the case in which one, a predetermined number or all of said threshold comparisons has or have indicated a threshold value being exceeded, and also the respective signal forwarded by the noise sensor exceeds the predetermined threshold value.

Advantageously, the first acceleration component can be oriented in the direction of an x-axis parallel to the fingers, the second acceleration component can be oriented in the direction of a y-axis that lies in the plane of the surface of the back of the hand and that is oriented normally to the x-axis, and the third acceleration component is oriented in the direction of a z-axis that is normal to the x-axis and the y-axis. Based on acceleration components produced at the same time or within a predetermined time window, the first acceleration component can then be compared with a first acceleration threshold value that lies between 34 m/s² and 61.5 m/s², and/or the second acceleration component can be compared with a second acceleration threshold value that lies between 30.5 m/s² and 46 m/s², and/or the third acceleration component can be compared with a third acceleration threshold value that lies between 22.5 m/s² and 34.5 m/s².

Other features which are considered as characteristic for the invention are set forth in the appended claims.

Although the invention is illustrated and described herein as embodied in a method and a device for counting shots fired from a handgun, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a diagrammatic, perspective view of a device according to the invention.

### DETAILED DESCRIPTION OF THE INVENTION

Referring now to the single FIGURE of the drawing in detail, there is shown a device which contains an attachment device 1, a housing 2, an acceleration sensor 3, a noise sensor 4 and a processing unit 5.

The attachment device 1 is embodied as a glove in the case of the embodiment of the invention represented in the FIGURE. The acceleration sensor 3, the noise sensor 4 and the processing unit 5 are advantageously disposed on the rear of the hand part of the glove 1, in particular on the side of the rear of the hand part of the glove facing away from the back of the hand. As the attachment device 1, alternatively an armband, attachment straps or even hook and loop straps can be provided that enable the attachment of the device, especially to the back of the hand or wrist.

The housing 2 is used as a carrier for the electronic components and encloses the sensors 3, 4 and the processing unit 5. The protection of the sensors 3, 4 and the processing unit 5 is advantageous in said embodiment. An alternative embodiment can be provided in which the electronic components are directly integrated within the attachment device 1 without having to be enclosed by a common housing 2.

The acceleration sensor 3 is embodied in the first embodiment of the invention represented in the FIGURE to measure the magnitude of the acceleration of the hand independently of the direction of acceleration and to transmit the same as a measurement signal to the processing unit 5. Usually, the accelerations of the hand lie in the region about 16 m/s². If a shot is fired from a handgun, an acceleration magnitude occurs in the range from 38 m/s² to 92.5 m/s² during the recoil movement. The acceleration sensor forwards a detected measurement value to the processing unit 5 that compares the relevant acceleration measurement value with a predetermined threshold value. The threshold value can be adopted between 22.5 m/s² and 61.5 m/s² depending on the respective weapon being used.

The acceleration sensor 3 can be embodied in an alternative embodiment so that in each case it detects the acceleration in the x-, y- and z-directions separately. Preferably, such an acceleration sensor is attached to the back of the hand or to the rear of the hand side of the glove, wherein the first axis, referred to below as the x-axis, is oriented parallel to the fingers. The second axis, referred to below as the y-axis, lies in the plane of the surface of the back of the hand and is oriented normally to the x-axis. The third axis, referred to below as the z-axis, is perpendicular to the x-axis and the y-axis. The individual components of the acceleration vector are approximately in the ranges mentioned below in relation to the aforementioned axes or coordinate directions when a shot is fired: In the x-direction, acceleration components occur in the range from 63.5 m/s² to 92.5 m/s². In the y-direction, acceleration components occur in the range from 60.5 m/s² to 80.5 m/s². In the z-direction, acceleration components occur in the range from 38 m/s² to 54 m/s². The acceleration sensor 3 forwards the measurement values for the individual acceleration components to the processing unit 5, which compares the relevant acceleration measurement value with a separate predetermined threshold value for the respective axial direction. The threshold value for the acceleration component along the x-axis can, depending on the respective weapon being used, can be adopted between 34 m/s² and 61.5 m/s². The threshold value for the acceleration component along the y-axis can, depending on the respective weapon being used, can be adopted between 30.5 m/s² and 46 m/s². The threshold value for the acceleration component along the z-axis can, depending on the respective weapon being used, can be adopted between 22.5 m/s² and 34.5 m/s². The processing unit 5 can also be embodied so that it already carries out detection of a shot on exceeding one of the threshold values or only on exceeding two or three of the threshold values.

By specifying a threshold value for the acceleration or by specifying threshold values for the individual acceleration components, it can advantageously be achieved that only the acceleration of the hand following a shot being fired results in the detection of a shot, but not other hand movements.

The noise sensor 4 measures the noise level and produces a signal corresponding to the noise level and transmits the signal to the processing unit 5. As a result of the shot being fired, a bang occurs that is loudest in the immediate vicinity of the handgun and a sound pressure level in the range of approximately 150 dB to 162 dB is reached there. The measurement signals of the noise sensor 4 are fed to the processing unit 5. The processing unit 5 compares the measurement signals with a predetermined threshold value that can be selected between 145 dB and 155 dB for example, depending on the respective weapon being used. Preferably, a threshold value for the sound pressure is selected that lies only slightly below the sound pressure to be expected when a shot is fired. Owing to such a specification of the threshold value for the sound pressure level, it can advantageously be achieved that no shots are detected that originate from other handguns.

The processing unit 5 continually performs, in particular at intervals of less than one millisecond, threshold comparisons for the incoming measurement values for the acceleration and sound pressure. A shot advantageously qualifies as detected if the relevant threshold values for the measurement values of the motion sensors 3 and for the measurement values of the noise sensor 4 are exceeded within a time window. The size of the time window is advantageously between 1 ms and 10 ms. Owing to this measure, it can advantageously be achieved that only shots fired from the relevant handgun are detected and no erroneous detection occurs owing to other movements of the shooter or owing to the firing noise of other shooters.

The processing unit 5 can be embodied so that it forwards the detected shots directly to an external unit or to an external memory. Alternatively or additionally, it can also be provided that the processing unit 5 increases a counter reading on detection of a shot.

Likewise, it can be provided that a display panel 6 that is visible to the shooter and on which the counter reading is displayed is provided on the device. A memory medium 7 for storing the counter reading can also be provided on the device, wherein advantageously a memory card is used as the memory medium 7.

The processing unit 5 can additionally detect the time interval between two shots fired from the relevant handgun. In this case, both the time separation between two directly successive shots and the time separation between the first and the last shots of a predetermined number of shots can be detected. The data can also be forwarded to an external unit or stored on a memory medium.

The time interval between two shots, possibly also the duration of a sequence of shots, can be displayed on a display that is visible to the shooter and that is integrated within the device. It can be provided that a maximum value for the time interval between the first and last shots is specified for the firing of a predetermined number of shots. Falling below or exceeding said maximum value can be notified to the shooter. This can for example be carried out by means of a visual signal. In particular, it can be provided that falling below the maximum value can be indicated by a display in a first color, whereas exceeding the maximum value can be indicated by means of a second color.

1. A device for detecting shots fired by a handgun, the device comprising:
an acceleration sensor implemented to measure an acceleration of a hand of an operator holding the handgun;
a noise sensor implemented to measure a sound pressure level of a sound of a shot;
a processing unit connected to said acceleration sensor and said noise sensor and receiving measurement signals from said acceleration sensor and said noise sensor, said processing unit configured to detect the shot if the measurement signals forwarded by said acceleration sensor and said noise sensor each exceed a predetermined threshold value within a predetermined time period; and
an attachment device attaching said acceleration sensor and said noise sensor to at least one of the hand or a wrist, and moves in synchronism with at least one of said hand or said wrist.

2. The device according to claim 1, wherein said processing unit is implemented to detect the shot if a measurement signal forwarded by said acceleration sensor exceeds a threshold value of 22.5 m/s² to 61.5 m/s² and/or the sound pressure level measured by said noise sensor exceeds a threshold value between 145 and 155 dB.

3. The device according to claim 1, wherein said processing unit is implemented to detect the shot if the measurement signals of said acceleration sensor and of said noise sensor exceed the predetermined threshold value and lie within no more than a 3 milliseconds range.

4. The device according to claim 1, wherein said processing unit is implemented to increase a counter reading when the shot is detected.

5. The device according to claim 4, further comprising a display panel for indicating the counter reading.

6. The device according to claim 5, further comprising a memory medium for storing the counter reading.

7. The device according to claim 6,
further comprising a common housing;
wherein said processing unit is implemented to forward a detection of the shot to an external unit; and
wherein at least one of said noise sensor, said acceleration sensor, said processing unit, said memory medium or said display panel are installed in said common housing.

8. The device according to claim 1, wherein:
said attachment device is a glove; and
said acceleration sensor, said noise sensor and said processing unit are disposed on a rear of a hand part of said glove.

9. The device according to claim 8, wherein:
said acceleration sensor is configured to determine an acceleration vector with at least two acceleration components, wherein signals relating to the acceleration components are delivered to said processing unit, and said processing unit is implemented to compare separately with respective separate threshold values based on the acceleration components produced at a same time or within a predetermined time window; and
said processing unit is configured to detect the shot in a case in which one, a predetermined number or all threshold comparisons have indicated a threshold value being exceeded, and a respective signal forwarded by said noise sensor exceeds the predetermined threshold value.

10. The device according to claim 9, wherein:
said acceleration sensor is attached to the rear of said hand part of said glove so that said acceleration sensor determines a first acceleration component in a direction of an x-axis, which is oriented parallel to fingers;
said acceleration sensor determines a second acceleration component in a direction of a y-axis, which lies in a plane of a surface of a back of the hand and is oriented normally to the x-axis;
said acceleration sensor determines a third acceleration component in a direction of a z-axis that is normal to the x-axis and the y-axis;
said processing unit is embodied to:
compare the first acceleration component with a first acceleration threshold value that lies between 34 m/s² and 61.5 m/s²;
compare the second acceleration component with a second acceleration threshold value that lies between 30.5 m/s² and 46 m/s²; and
compare the third acceleration component with a third acceleration threshold value that lies between 22.5 m/s² and 34.5 m/s².

11. The device according to claim 1, wherein said processing unit is configured to detect a time interval between two shots.

12. The device according to claim 11, further comprising a display panel for indicating the time interval between the two shots.

13. A method for detecting shots fired by a handgun, which comprises:
measuring an acceleration of a hand by means of an acceleration sensor;
measuring a sound pressure level of a sound of a shot by means of a noise sensor;
detecting a firing of the shot with the handgun if respective signals forwarded by the acceleration sensor and the noise sensor each exceed a predetermined threshold value within a predetermined time period; and
attaching the acceleration sensor and the noise sensor to the hand and/or to a wrist of a shooter, so as to move in synchronism with the hand and/or the wrist, before the shots are fired.

14. The method according to claim 13, which further comprises detecting the firing of the shot if a measurement value forwarded by the acceleration sensor exceeds a threshold value of 22.5 m/s² to 61.5 m/s², and/or the sound pressure level measured by the noise sensor exceeds a threshold value between 145 and 155 dB.

15. The method according to claim 13, which further comprises detecting the firing of the shot if the respective signals of the acceleration sensor and of the noise sensor exceeding the predetermined threshold value are detected within a time period of no more than 3 milliseconds.

16. The method according to claim 13, which further comprises incrementing a counter reading if the firing of the shot is detected.

17. The method according to claim 16, wherein the counter reading is indicated to the shooter, on a display disposed in a region of a back of the hand or the wrist, and/or that the counter reading is stored or forwarded to an external unit.

18. The method according to claim 13, which further comprises attaching the acceleration sensor and the noise sensor to a glove.

19. The method according to claim 13, which further comprises:
determining an acceleration vector with three acceleration components;
comparing the acceleration components separately with separate threshold values; and
detecting the shot in a case in which one, a predetermined number or all threshold comparisons have indicated a threshold value being exceeded, and a respective signal forwarded by the noise sensor (4) exceeds the predetermined threshold value.

20. The method according to claim 19, which further comprises:
orienting a first acceleration component in a direction of an x-axis parallel to fingers;
orienting a second acceleration component in a direction of a y-axis that lies in a plane of a surface of a back of the hand and that is oriented normally to the x-axis; and
orienting a third acceleration component in a direction of a z-axis that is normal to the x-axis and the y-axis;
performing at least one of the following steps based on the acceleration components produced at a same time or within a predetermined time window:
comparing the first acceleration component with a first acceleration threshold value that lies between 34 m/s² and 61.5 m/s²;
comparing the second acceleration component with a second acceleration threshold value that lies between 30.5 m/s² and 46 m/s²; or
comparing the third acceleration component with a third acceleration threshold value that lies between 22.5 m/s² and 34.5 m/s².

21. The method according to claim 13, which further comprises detecting a time interval between two shots.

22. The method according to claim 21, wherein the time interval between the two shots and/or exceeding a maximum value for the time interval between the two shots is indicated to a shooter on a display and/or is stored and/or is forwarded to an external unit.
